(19) United States
(12) Patent Application Publication
(10) Pub. No.: US 2026/0119544 A1
(43) Pub. Date: Apr. 30, 2026

(54) AUTOMATIC PRACTICABLE CONVERSATIONAL RECOMMENDATIONS

(71) Applicant: Roblox Corporation, San Mateo, CA (US)

(72) Inventors: Se-eun Yoon, San Mateo, CA (US); Xiaokai Wei, San Mateo, CA (US); Yexi Jiang, San Mateo, CA (US); Rachit Pareek, Fremont, CA (US); Frank Ong, San Mateo, CA (US); Kevin Gao, San Mateo, CA (US); Xiaohong Gong, Sunnyvale, CA (US)

(73) Assignee: Roblox Corporation, San Mateo, CA (US)

(21) Appl. No.: 19/368,237

(22) Filed: Oct. 24, 2025

Related U.S. Application Data
(60) Provisional application No. 63/712,200, filed on Oct. 25, 2024.

(51) Int. Cl. G06F 16/3329; G06F 16/338; G06F 16/34

(52) U.S. Cl. CPC G06F 16/33295; G06F 16/338; G06F 16/345

(57) ABSTRACT

A computer-implemented method provides automatic conversational recommendations. The computer-implemented method includes prompting an LLM to process a user request based on a formatted structure into a formatted request. The user request is natural language text. The computer-implemented method includes executing a plurality of tools by a tool policy to obtain item information from an item repository based on the formatted request. The computer-implemented method includes prompting the LLM with the user request and the item information to generate a list of items in response to the user request. The computer-implemented method includes causing a graphical user interface to display one or more items from the list of items.

### CROSS-REFERENCE TO RELATED APPLICATION(S)

This application is a non-provisional application that claims priority under 35 U.S.C. § 119(e) to U.S. Provisional Patent Application No. 63/712,200, filed on Oct. 25, 2024, the contents of which are hereby incorporated by reference herein in their entirety.

### TECHNICAL FIELD

Embodiments relate generally to online virtual experience platforms, and more particularly but not exclusively, to methods, systems, and computer readable media for automatic practicable conversational recommendations.

### BACKGROUND

Online platforms, such as virtual experience platforms (including online gaming platforms), may include a plurality of different available virtual experiences, games, activities, and others. Users may search for different available titles and receive results based on different search algorithms. However, as some users may be unfamiliar with some, most, or all titles available on some platforms, many users may receive search results that do not match a desired activity on the platform. In these and other scenarios, a user may receive results that rely on title text matching, phrase matching, keyword matching, tag similarity, and other conventional search algorithm results, which do not match what the user is seeking and therefore may reduce the chance that the user will enjoy engaging with one of the suggested items.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method to provide automatic conversational recommendations is provided. The computer-implemented method includes prompting a large language model (LLM) to process a user request into a formatted request. The user request is natural language text. The computer-implemented method includes executing a plurality of tools by a tool policy to obtain item information from an item repository based on the formatted request. The computer-implemented method includes prompting the LLM with the user request and the item information to generate a list of items in response to the user request. The computer-implemented method includes causing a graphical user interface to display one or more items from the list of items.

In some implementations, the formatted request may be in human-readable format.

In some implementations, prompting the LLM with the user request and the item information to generate the list of items in response to the user request includes prompting the LLM with the user request and item information to generate a ranked list of items in response to the user request.

In some implementations, causing the graphical user interface to display the one or more items from the list of items includes causing the graphical user interface to display the one or more items from the ranked list of items based on their respective ranks.

In some implementations, individual tools of the plurality of tools include an executable program that is configured to access the item repository. In some implementations, executing the plurality of tools includes running the executable program with one or more parameters obtained from the formatted request.

In some implementations, executing the plurality of tools by the tool policy to obtain the item information based on the formatted request includes, for an individual content-item title or an individual content-item genre indicated in the formatted request, returning, by at least one lookup tool, content-item metadata corresponding to a respective content-item title indicated in the formatted request.

In some implementations, executing the plurality of tools by the tool policy to obtain the item information based on the formatted request includes, for an individual content-item title or an individual content-item genre indicated in the formatted request, matching, by at least one linking tool, one or more of an official content-item title to the individual content-item title indicated in the formatted request or an official content-item category to the individual content-item genre indicated in the formatted request.

In some implementations, executing the plurality of tools by the tool policy to obtain the item information based on the formatted request includes, for an individual content-item title or an individual content-item genre indicated in the formatted request, retrieving, by at least one retrieval tool, at least one unspecified content item similar to a content item corresponding to the individual content-item title indicated in the formatted request.

In some implementations, executing the plurality of tools by the tool policy to obtain the item information based on the formatted request includes summarizing, by at least one formatting tool, results of one or more of a lookup tool, a linking tool, or a retrieval tool into a human-readable format.

In some implementations, executing the plurality of tools by the tool policy to obtain item information based on the formatted request further includes implementing, by an integrity tool, safety protocols to prevent one or more of irrelevant queries, policy violations, or jailbreaks.

In some implementations, prompting the LLM with the user request and the item information to generate the list of items in response to the user request includes instructing the LLM to generate a ranked list of N content-item recommendations based the user request and the item information.

In some implementations, the formatted request includes a blocked genre. In some implementations, the tool policy specifies that items that are associated with the blocked genre are to be excluded from the list of items.

In some implementations, the LLM includes a first model and a second model different from the first model. In some implementations, the formatted request is generated by the first model and the list of items is generated by the second model.

In some implementations, the formatted request has a formatted structure that includes user preferences and user demographics. In some implementations, the user preferences specify one or more attributes from item genre, item name, item properties, and item compatibility, and a value that indicates whether an attribute of the one or more attributes is a positive attribute or a negative attribute. In some implementations, the user demographics specify one or more of gender, age, location, or a combination thereof.

According to another aspect of the present disclosure, a non-transitory computer-readable medium with instructions stored thereon that, when executed by one or more hardware processors, cause the one or more hardware processors to perform or control performance of operations. The operations include prompting an LLM to process a user request based on a formatted structure into a formatted request. The user request is natural language text. The operations include executing a plurality of tools by a tool policy to obtain item information from an item repository based on the formatted request. The operations include prompting the LLM with the user request and the item information to generate a list of items in response to the user request. The operations include causing a graphical user interface to display one or more items from the list of items.

In some implementations, the formatted request may be in human-readable format.

In some implementations, prompting the LLM with the user request and the item information to generate the list of items in response to the user request includes prompting the LLM with the user request and item information to generate a ranked list of items in response to the user request.

In some implementations, causing the graphical user interface to display the one or more items from the list of items includes causing the graphical user interface to display the one or more items from the ranked list of items based on their respective ranks.

In some implementations, individual tools of the plurality of tools include an executable program that is configured to access the item repository. In some implementations, executing the plurality of tools includes running the executable program with one or more parameters obtained from the formatted request.

In some implementations, executing the plurality of tools by the tool policy to obtain the item information based on the formatted request includes, for an individual content-item title or an individual content-item genre indicated in the formatted request, returning, by at least one lookup tool, content-item metadata corresponding to a respective content-item title indicated in the formatted request.

In some implementations, executing the plurality of tools by the tool policy to obtain the item information based on the formatted request includes, for an individual content-item title or an individual content-item genre indicated in the formatted request, matching, by at least one linking tool, one or more of an official content-item title to the individual content-item title indicated in the formatted request or an official content-item category to the individual content-item genre indicated in the formatted request.

In some implementations, executing the plurality of tools by the tool policy to obtain the item information based on the formatted request includes, for an individual content-item title or an individual content-item genre indicated in the formatted request, retrieving, by at least one retrieval tool, at least one unspecified content item similar to a content item corresponding to the individual content-item title indicated in the formatted request.

In some implementations, executing the plurality of tools by the tool policy to obtain the item information based on the formatted request includes summarizing, by at least one formatting tool, results of one or more of a lookup tool, a linking tool, or a retrieval tool into a human-readable format.

In some implementations, executing the plurality of tools by the tool policy to obtain item information based on the formatted request further includes implementing, by an integrity tool, safety protocols to prevent one or more of irrelevant queries, policy violations, or jailbreaks.

In some implementations, prompting the LLM with the user request and the item information to generate a list of items in response to the user request includes instructing the LLM to generate a ranked list of N content-item recommendations based the user request and the item information.

In some implementations, the formatted request includes a blocked genre. In some implementations, the tool policy specifies that items that are associated with the blocked genre are to be excluded from the list of items.

In some implementations, the LLM includes a first model and a second model different from the first model. In some implementations, the formatted request is generated by the first model and the list of items is generated by the second model.

In some implementations, the formatted request has a formatted structure that includes user preferences and user demographics. In some implementations, the user preferences specify one or more attributes from item genre, item name, item properties, and item compatibility, and a value that indicates whether an attribute of the one or more attributes is a positive attribute or a negative attribute. In some implementations, the user demographics specify one or more of gender, age, location, or a combination thereof.

According to a further aspect of the present disclosure, a computing device is provided. The computing device includes one or more hardware processors. The computing device includes a non-transitory computer readable medium coupled to the one or more hardware processors, with instructions stored thereon, that when executed by the one or more hardware processors, cause the one or more hardware processors to perform or control performance of operations. The operations include prompting an LLM to process a user request based on a formatted structure into a formatted request. The user request is natural language text. The operations include executing a plurality of tools by a tool policy to obtain item information from an item repository based on the formatted request. The operations include prompting the LLM with the user request and the item information to generate a list of items in response to the user request. The operations include causing a graphical user interface to display one or more items from the list of items.

In some implementations, the formatted request may be in human-readable format.

In some implementations, prompting the LLM with the user request and the item information to generate the list of items in response to the user request includes prompting the LLM with the user request and item information to generate a ranked list of items in response to the user request.

In some implementations, causing the graphical user interface to display the one or more items from the list of items includes causing the graphical user interface to display the one or more items from the ranked list of items based on their respective ranks.

In some implementations, individual tools of the plurality of tools include an executable program that is configured to access the item repository. In some implementations, executing the plurality of tools includes running the executable program with one or more parameters obtained from the formatted request.

In some implementations, executing the plurality of tools by the tool policy to obtain the item information based on the formatted request includes, for an individual content-item title or an individual content-item genre indicated in the formatted request, returning, by at least one lookup tool, content-item metadata corresponding to a respective content-item title indicated in the formatted request.

In some implementations, executing the plurality of tools by the tool policy to obtain the item information based on the formatted request includes, for an individual content-item title or an individual content-item genre indicated in the formatted request, matching, by at least one linking tool, one or more of an official content-item title to the individual content-item title indicated in the formatted request or an official content-item category to the individual content-item genre indicated in the formatted request.

In some implementations, executing the plurality of tools by the tool policy to obtain the item information based on the formatted request includes, for an individual content-item title or an individual content-item genre indicated in the formatted request, retrieving, by at least one retrieval tool, at least one unspecified content item similar to a content item corresponding to the individual content-item title indicated in the formatted request.

In some implementations, executing the plurality of tools by the tool policy to obtain the item information based on the formatted request includes summarizing, by at least one formatting tool, results of one or more of a lookup tool, a linking tool, or a retrieval tool into a human-readable format.

In some implementations, executing the plurality of tools by the tool policy to obtain item information based on the formatted request further includes implementing, by an integrity tool, safety protocols to prevent one or more of irrelevant queries, policy violations, or jailbreaks.

In some implementations, prompting the LLM with the user request and the item information to generate a list of items in response to the user request includes instructing the LLM to generate a ranked list of N content-item recommendations based the user request and the item information.

In some implementations, the formatted request includes a blocked genre. In some implementations, the tool policy specifies that items that are associated with the blocked genre are to be excluded from the list of items.

In some implementations, the LLM includes a first model and a second model different from the first model. In some implementations, the formatted request is generated by the first model and the list of items is generated by the second model.

In some implementations, the formatted request has a formatted structure that includes user preferences and user demographics. In some implementations, the user preferences specify one or more attributes from item genre, item name, item properties, and item compatibility, and a value that indicates whether an attribute of the one or more attributes is a positive attribute or a negative attribute. In some implementations, the user demographics specify one or more of gender, age, location, or a combination thereof.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram of example natural-language user requests, in accordance with some implementations.

FIG. 3 is a diagram of an example dataset collection procedure for practicable conversational recommendation, in accordance with some implementations.

FIG. 4 is a diagram of an example practicable conversational recommendation system, in accordance with some implementations.

FIG. 5 is a diagram of an example list of tools for practicable conversational recommendation, in accordance with some implementations.

FIG. 6 is a diagram of an example tool-execution policy for practicable conversational recommendation, in accordance with some implementations.

FIG. 7 is a diagram illustrating example evaluation metrics measured for various recommendation procedures, in accordance with some implementations.

FIG. 8 is a diagram illustrating results of an ablation study on the number of tools executed in the tool policy, in accordance with some implementations.

FIG. 9 illustrates a diagram of an example user interface for presenting results of practicable conversational recommendation, in accordance with some implementations.

FIG. 10 is a flowchart of an example method of practicable conversational recommendation, in accordance with some implementations.

FIG. 11 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of automatic practicable conversational recommendations. For example, many users searching for new games may face thousands to millions of available options on one or more platforms. However, actually “trying out” various games can be time-consuming. In comparison, during conversation with another person, users may explain their gaming or virtual experience preferences by saying in natural language what they want to play, see, or otherwise interact with.

For example, users may, in a conversation, express their needs through diverse expressions. As an example, a user may say, “I'm new to this platform, but I enjoy first-person shooter games. Can you recommend some?” As another example, a user may say, “I'm looking for an experience to play with my nephews who are 7 and 10 years old. They love to play simple games on tablets, but I play more complex games on a personal computer. Here are some examples of what I have played . . . can you recommend something similar?” It is noted that these are non-limiting examples.

Some conversational recommender systems (CRS) suffer from the difficulty of generating high-quality recommendations from these types of complex user queries. For example, even though some large language models (LLMs) have been demonstrated to be effective in conversational movie recommendations, LLMs by themselves cannot be directly applied to many industrial domains.

One limitation of LLMs is their dependence on fixed parameters, which restricts their ability to manage a dynamic pool of items and integrate up-to-date world knowledge without the costly process of fine-tuning. Furthermore, LLMs exhibit high popularity bias, frequently recommending or addressing the most well-known items compared to human oracles (an item recommended by another user).

However, as described herein, a practicable CRS is provided that addresses these and other drawbacks. First, a dataset of real user requests and recommendations is collected from third-party or external sources of real recommendations (e.g., an online discussion forum where users discuss items maintained by an online virtual experience platform online), which is used to evaluate a trained model for initial deployment. Second, an approach that augments LLMs with multiple specialized tools, each capable of accessing external knowledge bases and domain-specific models, is used.

The practicable CRS's LLM (e.g., one or more LLM(s)) formats the raw intent of a natural language statement(s), applies a tool-execution policy, and incorporates the results for generating the recommendations. For instance, one or more of the following operations may be performed by the practicable CRS:

1) Formatted intent generation: an LLM is prompted to process a natural-language user request into a formatted JSON structure or other suitable structure;

2) Tool execution: given the formatted intent, multiple tools (e.g., Python functions, for example, 5, 10, 15, or more tools) are executed by a policy to obtain relevant information. It is noted that conventional LLMs typically use a much more limited set of tools;

3) Generative recommendation: an LLM is prompted with the natural-language user request and provides a list of one or more relevant items; and

4) Item linking: the LLM output is parsed and linked to a real item in the system database and displayed to the user.

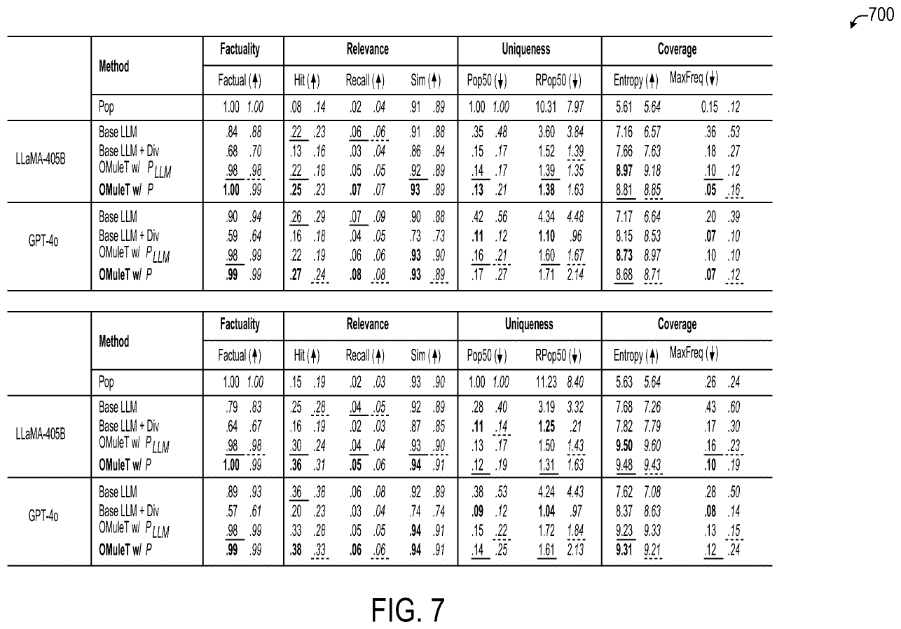

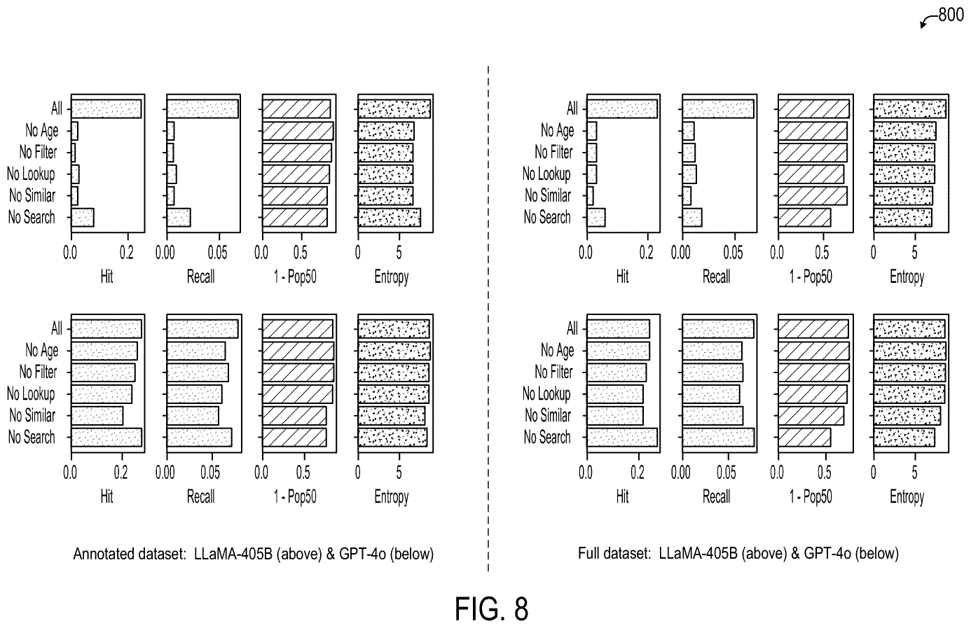

While most CRS LLMs use synthetic requests derived from traditional user-item interactions, such requests can be effectively handled by using just one-to-four tools. However, real user expressions differ significantly from synthetic requests, often involving free-form casual utterances (e.g., a user may say “PTFS” to refer to the game “Pilot Training Flight Simulator”) and complex conditions based on genres, properties, age ranges, and compatible devices. As demonstrated in example results (see FIGS. 7 and 8), addressing these expressions involves a larger variety of tools to achieve a desirable performance. The practicable CRS is evaluated and is shown to improve over base LLMs in terms of one or more of factualness, relevance, serendipity, uniqueness and coverage.

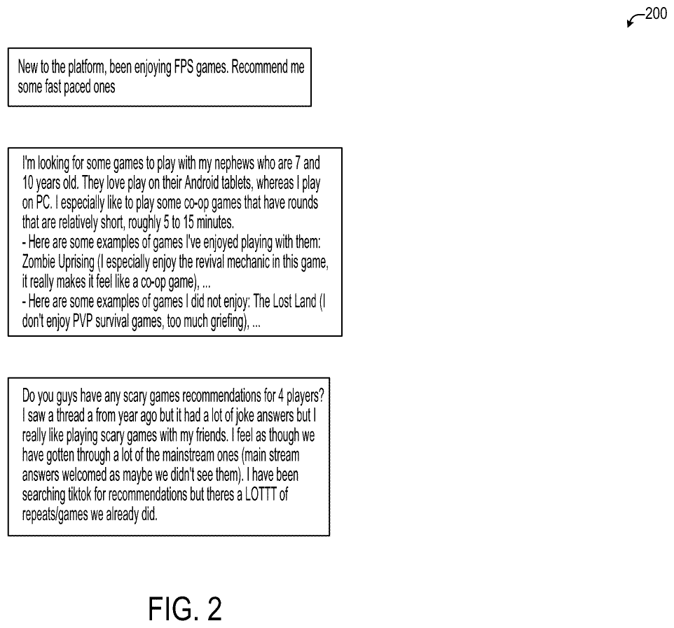

Accordingly, as described herein, a practicable CRS that leverages these aspects may be implemented using natural-language user form requests as input to retrieve the most relevant items from a platform (e.g., such as a virtual experience platform, gaming platform, and/or platforms providing a variety of content for searching, etc.). The practicable CRS may improve a user's experience in navigating through a vast number of item choices, while at the same time reducing the computational load on a server implementing a search algorithm, reducing the network-bandwidth use by limiting the number of user requests performed to identify an engaging item, reducing power consumption through more efficient search results, and increasing platform revenue by providing better search results, and others. Such technical effects and benefits may become apparent through one or more of the solutions provided in detail below with reference to FIGS. 2-10.

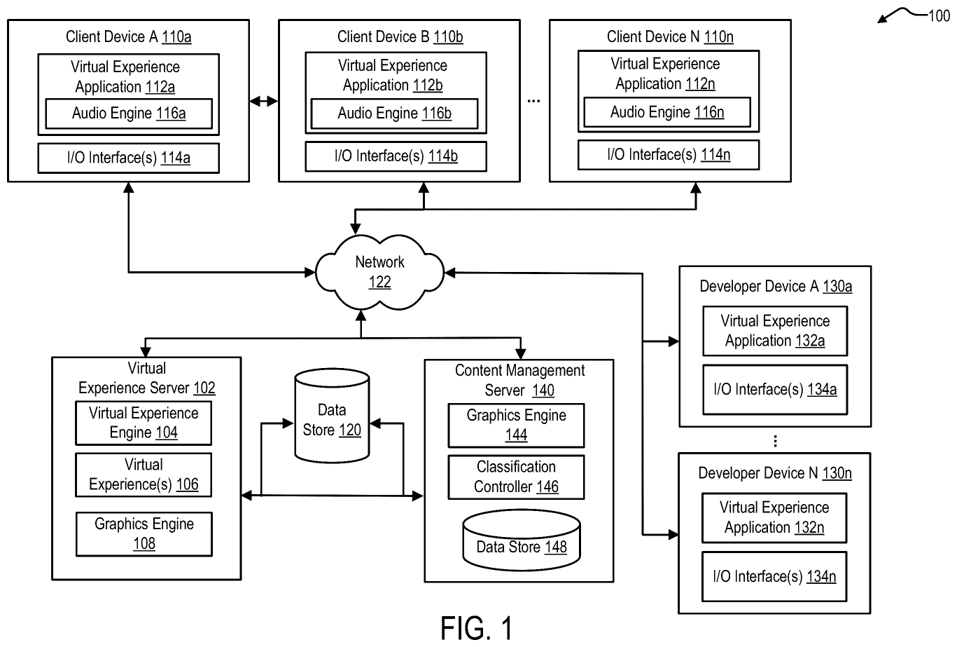

FIG. 1 is a diagram of an example system architecture 100 that includes a virtual experience platform that can support practicable conversational recommendation, in accordance with some implementations. In the example of FIG. 1, the 3D environment platform or network environment (e.g., the system architecture 100) will be described in the context of an online virtual experience server 102 purely for purposes of explanation, and various other implementations can provide other types of 3D environment platforms, such as online meeting platforms, virtual reality (VR) or augmented reality (AR) platforms, or other types of platforms that can provide 3D content. The description provided herein for the online virtual experience server 102 and other elements of the system architecture 100 can be adapted to be operable with such other types of 3D environment platforms.

Virtual experience platforms (also referred to as “user-generated content platforms” or “user-generated content systems”) offer a variety of ways for users to interact with one another, such as while the users are playing an electronic virtual experience. For example, users of a virtual experience platform may work together towards a common goal, share various virtual gaming items, send electronic messages to one another, and so forth. Users of a virtual experience platform may play virtual experiences using characters, such as the 3D avatars, which the users can navigate through a 3D world rendered in the electronic virtual experience.

A virtual experience platform may also enable users of the platform to create and animate avatars, as well as enabling the users to create other graphical objects to place in the 3D world. For example, users of the virtual experience platform may be allowed to create, design, and customize the avatar, and to create other 3D objects for presentation in the 3D world.

FIG. 1 is a diagram of an example network environment (having a system architecture 100) to enable practicable conversational recommendation, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), content management server 140, and developer devices 130a and 130n (generally referred to as “developer device(s) 130” herein). Virtual experience server 102, content management server 140, data store 120, client devices 110, and developer devices 130 are coupled via network 122. In some implementations, client devices 110 and developer device(s) 130 may refer to the same or same type of device.

Online virtual experience server 102 can include a virtual experience engine 104, one or more virtual experience(s) 106, and graphics engine 108. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the client device by a cable (wired) or that are wirelessly connected.

Content management server 140 can include a graphics engine 144 and a classification controller 146. In some implementations, the content management server 140 may include a plurality of servers. In some implementations, the plurality of servers may be arranged in a hierarchy (e.g., based on respective prioritization values assigned to content sources).

Graphics engine 144 may be utilized for the rendering of one or more objects (e.g., 3D objects associated with the virtual environment). Classification controller 146 may be utilized to classify assets such as 3D objects and for the detection of inauthentic digital assets, etc. Data store 148 may be utilized to store a search index, model information, etc.

A developer device 130 can include a virtual experience application 132 and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.” In some contexts, a “user” may be a system administrator, a developer, a content provider, or other type of entity that may have privileges/capabilities that are different from those of an end user.

In some implementations, online virtual experience server 102 may be an online gaming server. For example, the online virtual experience server 102 may provide single-player or multiplayer games to a community of users that may access or interact with games using client devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using client devices (e.g., 110) within a game (e.g., game that is part of virtual experience 106) or the presentation of the interaction on a display or other output device (e.g., 114) of a client device 110. References to a game and related functionality are provided herein for purposes of illustrating/describing various features, and such features can be adapted for other types of virtual experiences that may not necessarily involve games.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience 106 (e.g., a game) may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the client devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 112/132 may be associated with a particular user or a particular group of users (e.g., a private game) or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of client devices 110 may work independently, in collaboration with virtual experience engine 104 of online virtual experience server 102, or a combination of both.

In some implementations, both the online virtual experience server 102 and client devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual application 112/132 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on gameplay conditions. For example, if the number of users participating in gameplay of a particular virtual experience 106 exceeds a threshold number, the online virtual experience server 102 may perform one or more virtual experience engine functions that were previously performed by the client devices 110.

For example, users may be playing a virtual experience application 112 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send gameplay instructions (e.g., position and velocity information of the characters participating in the group gameplay or commands, such as rendering commands, collision commands, etc.) to the client devices 110 based on control instructions. For instance, the online virtual experience server 102 may perform one or more logical operations (e.g., using virtual experience engine 104) on the control instructions to generate gameplay instruction(s) for the client devices 110. In other instances, online virtual experience server 102 may pass one or more or the control instructions from one client device 110 to other client devices (e.g., from client device 110a to client device 110b) participating in the virtual experience application 112. The client devices 110 may use the gameplay instructions and render the gameplay for presentation on the displays of client devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates gameplay instructions using a local virtual experience engine. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a client device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar (e.g., a virtual character such as a humanoid character, an animal-character, a robot-character, etc.).

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory (e.g., a hat, a weapon, a piece of clothing, etc. worn by a virtual avatar or otherwise depicted with reference to a virtual avatar).

In some implementations, a platform may enable users to submit (upload) candidate 3D objects for utilization on the platform. A virtual experience development environment (e.g., a developer tool) may be provided by the platform, in accordance with some implementations. The virtual experience development environment may provide a user interface that enables a developer user to design and/or create virtual experiences (e.g. games). The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience (e.g., a game developer or any other person who seeks to create a virtual experience that may be published by an online virtual experience platform and utilized by others). The user interface of the virtual experience development environment may be rendered on a display screen of a client device (e.g., such as a developer device 130 described with reference to FIG. 1), so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “client device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application 112 may include an audio engine 116 that is installed on the client device 110, and which enables the playback of sounds on the client device 110. In some implementations, audio engine 116 may act cooperatively with graphics engine 144 that is installed on the server 140.

According to aspects of the disclosure, the virtual experience application 112 may be an online virtual experience server application for users to build, create, edit, and upload content to the online virtual experience server 102, as well as interact with online virtual experience server 102 (e.g., participate in virtual experiences 106 hosted by online virtual experience server 102). As such, the virtual experience application 112 may be provided to the client device(s) 110 by the online virtual experience server 102. In another example, the virtual experience application 112 may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experience applications 132 developed, hosted, or provided by a virtual experience application developer.

In some implementations, a user may login to online virtual experience server 102 via the virtual experience application 112. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, which are owned by or associated with other users.

In general, functions described in one implementation as being performed by the online virtual experience server 102 can also be performed by the client device(s) 110, a server, and/or other device(s) usable in the system architecture 100 of FIG. 1 in other implementations if appropriate. In addition, the functionality attributed to a particular component can be performed by different or multiple components operating together. The online virtual experience server 102 can also be accessed as a service provided to other systems or devices through appropriate application programming interfaces (APIs) and thus is not limited to use in websites.

In some implementations, online virtual experience server 102 may include a graphics engine 108. In some implementations, the graphics engine 108 may be a system, application, or module that permits the online virtual experience server 102 to provide graphics and animation capability.

In some implementations, the virtual-experience server 102 and/or client device 110 may perform one or more of the operations described below with reference to FIGS. 2-10 or otherwise described herein.

FIG. 2 is a diagram of example natural-language user requests 200, in accordance with some implementations. Such requests 200 may be submitted by users via client device 110 and may be received via virtual-experience server 102.

Imagine a user who wants to find new games but faces thousands to millions of options. Since trying out various games or other content items can be time consuming, a user may want to receive recommendations simply by saying in natural language what she or he wants to play or interact with. Examples of such natural-language user requests 200 are depicted in FIG. 2, where users express their needs through diverse expressions. The practicable CRS described herein receives such free-form requests and retrieves the most relevant items or otherwise relatively more relevant items to improve the user's experience in navigating through a vast number of content choices. The recommendation technique(s) implemented by the practicable CRS improves upon other systems through at least the following.

First, a dataset of real user requests and recommendations is collected. This distinguishes from other CRS, which are trained using synthetic queries generated from traditional user-item interactions. Real user requests (also referred to herein as “natural-language user requests”) are more challenging to process than requests synthesized from templates due to their variety, unstructured nature, and subjective language. Second, to process such complex requests, the practicable CRS employs a larger variety of tools to augment the LLM for recommendations, compared to other approaches that address synthetic queries with a more limited set of tools. For example, the free-form utterances (e.g., using “PTFS” to refer to the game “Pilot Training Flight Simulator”) of a natural-language user request(s) in the practicable CRS are processed using specialized tools, which are not used to process synthetic request that use clearly defined item names. Another example is handling conditions, such as a user who wants to play games on a personal computer (PC) and wants to play with 13 and 16-year-old nephews who use tablets and provides a list of liked and disliked games and reasons. Using just a search application programming interface (API) or lookup API may be insufficient for handling these types of conditions. In comparison, the practicable CRS uses multiple tools to process factors such as games popular among different age groups (e.g., 13-17, 18-24, 25-35, etc.), device compatibility, and similar items search.

Third, the practicable CRS augments LLM(s) with a diverse set of tools to meet complex requests. Using this framework, utterances from natural-language user requests are processed into a formatted intent, a tool-execution policy is applied thereto, and the recommendations of the LLM(s) are augmented with the utterances from the natural-language user request. This approach not only makes the system transparent and controllable, but it is more effective in terms of performance as compared to other technique(s) where an LLM generates its own tool execution policy. Further, an extensive evaluation on two LLMs (e.g., LLAMA-405B and GPT-40) and eight metrics covering factuality, relevance, uniqueness, and diversity was performed, the results of which are described below with reference to FIGS. 7 and 8. As described later, the results show that using the present framework is more effective than baseline LLMs and that using a more diverse set of tools improves performance.

Given a natural-language user request, the practicable CRS may be instructed to return a list of k items. The success of this task may be measured by multiple criteria. First, the items should be relevant to the request; namely, the results should be what the user is asking for. An approach to evaluate relevance is to obtain direct feedback from the user who made the request. However, in the early stages of model deployment, obtaining feedback for each iteration is impractical. Thus, evaluation data as a proxy for relevance may be constructed. Another criterion for measuring success is that that returned items are unique; this is because the goal of recommendation is closely tied to discovery. Explained in another way, recommending highly popular items (items that often appear on the platform's landing page) should be avoided. Further, the collection of recommended items across all requests should have high coverage, ensuring a diverse range of recommendations. This breadth of visibility is beneficial for a platform that maintains a vast number items.

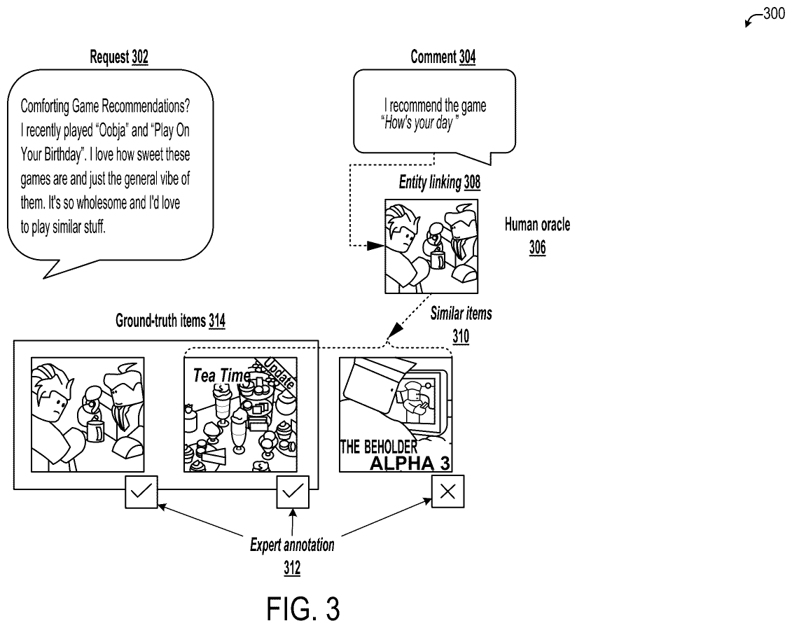

FIG. 3 is a diagram of an example dataset collection procedure 300 for practicable conversational recommendation, in accordance with some implementations. In some implementations, the procedure 300 may be performed by virtual-experience server 102.

To perform dataset collection, information from an online discussion forum where users discuss a wide range of topics relating to an online virtual experience platform and its content items may be obtained. To identify requests 302, a Python function or other suitable/analogous function may be executed to sample posts, using key phrases such as “recommend me games” and “what games to play.” Further filtering may be performed using a machine learning model (e.g., GPT-3.5 or other suitable/analogous model) to judge whether the request is asking for game recommendations and then removing the ones that are not. This process may leave some irrelevant posts, such as a game developer asking for recommendations on what game to make. As such, the irrelevant posts may be removed using another filter or manually.

For each request 302, there may be comments 304 from other users of the online forum that recommend relevant games, which may be referred to as human oracles 306. When a user suggests a game, the title included in the comment 304 may not precisely match the official game title, instead referring to it with an acronym (e.g., “MM2” instead of “Murder Mystery 2”) or leaving out parts of the name (e.g., “Bloxburg” instead of “Welcome to Bloxburg”). To handle this scenario, the machine learning model (e.g., GPT-3.5 or other suitable/analogous model) may extract any phrase(s) that might include a game name and perform entity linking 308 to a corresponding game identifier (ID) in an item repository using a search function. To improve the quality of the human oracles 306, community agreement through the net upvotes of comments 304 may be measured. For each request 302, games that have at least one net upvote may be kept and the rest may be discarded.

Human oracles 306 may be noisy (e.g., some games are still irrelevant) or insufficient (e.g., there may be more games that are relevant to a request 302). The set of recommendations may be refined through a two-step process. First, for each request 302, a candidate set of games may be generated. This may be accomplished using the human oracles 306 to obtain similar items 310 using various functionality. Human oracles 306 and similar items 310 may be added to the candidate set by prioritizing their frequency across all oracles and API(s), with up to N candidates (e.g., 30 candidates) generated per request 302. Second, human experts may determine whether each candidate is relevant to the request 302, which she or he indicates with expert annotations 312. These experts are highly knowledgeable about the content items maintained by the online virtual experience platform. To provide safety, the human experts remove any age-inappropriate content items based on the request 302. The resulting items may be denoted as the ground-truth items 314 for a given request 302.

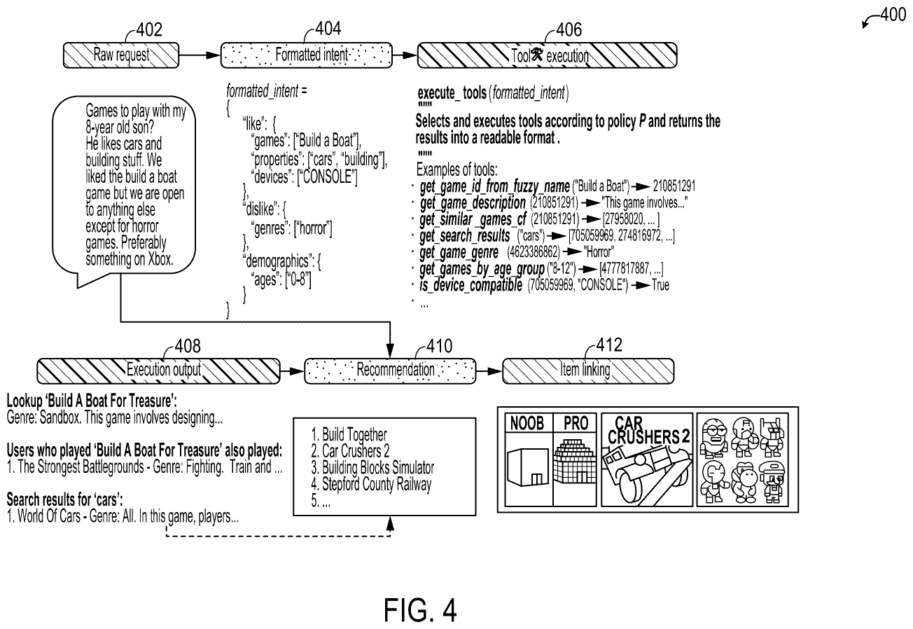

FIG. 4 is a diagram of an example practicable CRS 400, in accordance with some implementations. The practicable CRS 400 may reside in, for example, online virtual experience server 102, virtual experience engine 104, client device 110, virtual experience application 112, developer device 130, virtual experience application 132, or any other device or component of FIG. 1. The practicable CRS 400 may be implemented with an orchestrating multiple tools (OMuleT) framework.

Although not shown, practicable CRS 400 includes various LLM(s) and/or engines to perform the example operations depicted in FIG. 4. For example, a first LLM may be configured to receive a natural-language user request 402, from which it may generate a formatted intent 404. The practicable CRS 400 may also include a tool-execution engine that may execute a tool-execution policy 406 and provide an execution output 408. A second LLM (which may be the same or different than the first LLM) may generate a recommendation 410 based on the execution output 408 augmented with the natural-language user request 402. Then, an item-linking engine may link the recommendations 410 to items 412 displayed to the user.

For example, when a natural-language user request 402 is submitted by a user, a first LLM may generate a summary of the user's preference(s), denoted as the formatted intent 404. The formatted intent 404 may be provided as input to a tool-execution engine that implements a tool-execution policy 406. The tool-execution policy 406 may select the tools and arguments to execute to generate an execution output 408 in natural language. The execution output 408 is not the final recommendation. Instead, the execution output 408 contains relevant information that augments the LLM with external knowledge (e.g., item information) so that the LLM generates better recommendations 410. In the recommendation phase, both the natural-language user request 402 and the execution output 408 are provided to the LLM, which generates a list of item names. Each item is then linked to an item 412 in the platform's item repository.

While it is possible to make LLMs directly generate code policies for tool execution, this may not be effective for the desired task of the practicable CRS 400. Furthermore, the practicable CRS 400 is designed such that its operations are transparent and controllable. For instance, the following system design may be provided: the LLM first processes the natural-language user request 402 into a formatted intent (Dᵢₙₜ) 404 and executes a tool-execution policy (P) 406 based on the formatted intent 404.

This implementation of the practicable CRS 400 provides several benefits: 1) it allows the developer to view the formatted intent 404, enabling the assessment of incoming requests and the verification of whether the natural-language user request 402 is being understood or parsed correctly; 2) instead of depending on LLMs for code generation-which can be a black box and have syntax errors-a human expert may be used to improve the execution of tools; and 3) it improves performance compared to LLM-generated tool policies. By way of example and not limitation, the practicable CRS 400 may use the following prompt: “Given a user's recommendation request, format the user's preference into a JSON format. Fill in the following template of dict[str, dict[str, list]] with relevant information accurately extracted from the user's request: <template><demonstrations>.”

The <template> includes preferences and user demographics, where each preference (“like” and “dislike”) includes four fields: 1) Genres: approximate item genres that do not need to make official item categories exactly; 2) Game names: approximate game names that does not need to match official item titles exactly; 3) Properties: simple key phrases describing the features or elements of an item; and 4) Devices: a subset of “DESKTOP,” “PHONE,” “TABLET,” “CONSOLE,” and “VIRTUAL REALITY (VR).”

User demographics may include two fields: 1) Ages: age group(s) of user(s) from a subset of “13-17,” “18-24,” “25-34,” and “35 and over;” and 2) Genders: gender(s) of user(s) inferred from explicit information in the request (e.g., “my son”-> “MALE”).

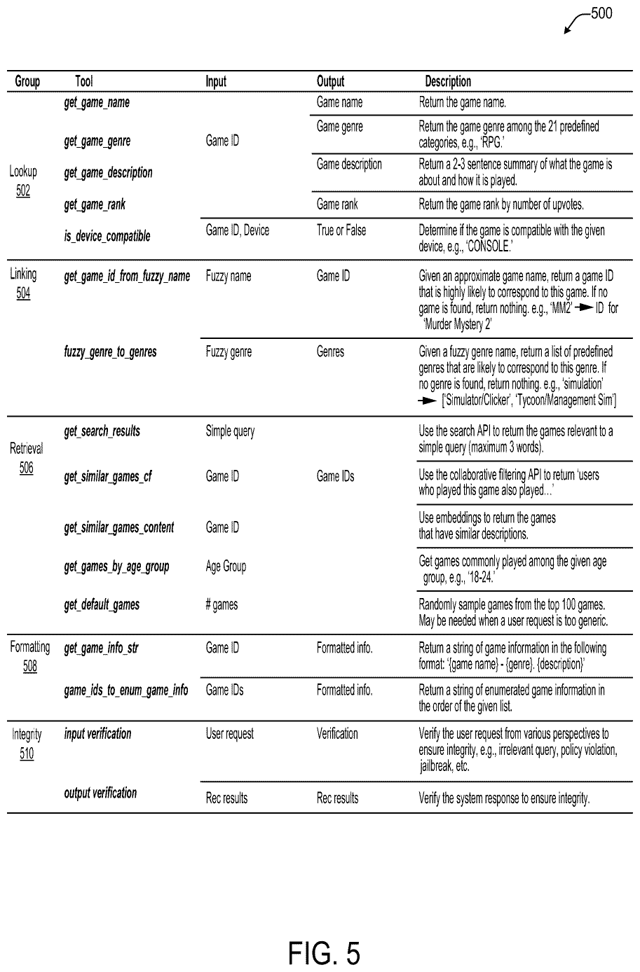

Additional details of the tool-execution policy 406 will now be provided with reference to FIG. 5.

FIG. 5 is a diagram of an example list of tools 500 for the tool-execution policy 406, in accordance with some implementations. The example tools listed in in FIG. 5 may be Python functions or other suitable/analogous functions that each perform a dedicated task that is useful for recommendation.

In FIG. 5, the list of tools 500 available to the tool-execution policy 406 is shown, along with each tool's input, output, and description. The tools are broadly classified into four categories: lookup tools, linking tools, retrieval tools, and formatting tools.

Lookup tools 502 may be used for informing LLMs with item knowledge (e.g., game description) or filtering items based on attributes (e.g., compatible devices). Other systems use a single lookup tool by structured query language (SQL) query generation, but this method may not be suitable for many applications, including the one described herein. Instead, the practicable CRS 400 uses multiple tools 502 for accessing the database/repository. This feature enables system transparency and controllability.

Linking tools 504 match item names and genres from user utterances in the natural-language user requests to corresponding item ID or official genre categories into which items are classified in the item repository. Linking tools 504 are beneficial for handling natural-language user requests where exact game IDs or genre categories are not used.

Retrieval tools 506 retrieve games that may be relevant to the natural-language user request. For example, if a user references an item to express her or his preference, the similarity-search tools retrieve similar items using collaborative filtering (based on similar users) and game content (based on descriptions). While similar to candidate generators, recommendations may not be confined to the retrieved items. Instead, the retrieval tools 506 are used to enable the LLMs to be “aware” of the diverse items in the database/repository instead of generating the most popular ones. As shown later, the absence of these tools 506 results in much lesser diversity of recommended items.

Formatting tools 508 summarize the tool execution results into a natural language format, which may be provided in the prompt for the recommendation stage.

Integrity tools 510 provide overall system safety by preventing irrelevant queries, policy violations, and jailbreaks.

In some implementations, the system may not use ranking tools. Instead, the LLM(s) provide the eventual recommendation by enumerating a list of items, as discussed later.

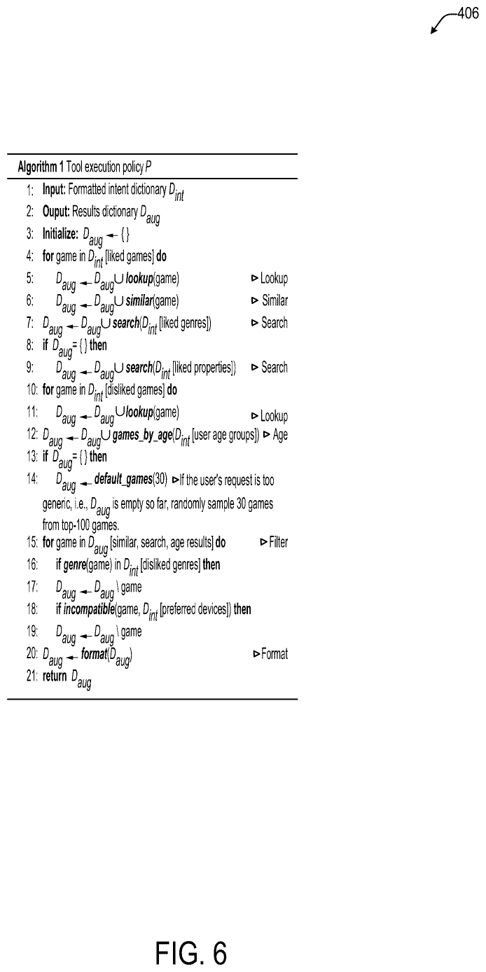

FIG. 6 is a diagram of an example tool-execution policy 406 (e.g., Dᵢₙₜ→D_{aug}) for practicable conversational recommendation, in accordance with some implementations.

The tool-execution policy 406 identifies each (key, value) in the formatted intent and runs the corresponding tools, adding information to D_{aug} that may be potentially helpful to the recommendation stage. Then, the tool-execution policy 406 goes through D_{aug} again and filters items that can be sources of noise (e.g., items that are incompatible with the user's preferred devices). While filtering can be skipped and irrelevant items in the final recommendation stage can be disregarded by the LLMs, filtering items in advance may improve recommendation performance. Further, the tool-execution policy 406 uses the formatting tools 508 to convert D_{aug} into a readable format to be passed into the recommendation stage. For example,

```
      {“Users who played id0 also played”: [id1, id2,...]}
  becomes
User who played “Da Amazing Bunker Simulator” also played:
    1. RetroStudio - Genre: Sandbox. This game allows
      players to create...
```

To generate high-quality recommendations, the LLM accurately provides recommendations for complex and nuanced natural-language user requests. Instead of having a separate ranking tool to generate the ranked list of final recommendations, the practicable CRS prompts an LLM with the natural-language user request, the tool execution output D_{aug}, and an instruction to generate a list of relevant items. This technique utilizes the LLM's language capability (e.g., processing the natural-language user request with a higher degree of accuracy) and augments the LLM's weakness by providing external knowledge (e.g., the tool-execution output). The following example instruction may be used: “Given the following request, provide recommendations. Enumerate 20 game names (1., 2., . . . ) in the order of relevance. Don't say anything else.” The LLM may be augmented with D_{aug} by adding: “Using the above information along with your own knowledge and reasoning, provide the best recommendations that fulfill the request.”

FIG. 7 is a diagram illustrating example evaluation metrics 700 measured for various recommendation procedures, in accordance with some implementations. In FIG. 7, the results for the top-five recommendations (above) and the top-ten recommendations (below), on human-annotated and full (italicized) datasets.

Multiple evaluation metrics for relevance, uniqueness, and coverage of recommended items are shown. Additionally, since the LLM is used as a recommender, the factuality is measured to identify whether the LLM is hallucinating.

Relevance: Hit@k evaluates whether a ground-truth item is included in the top-k recommendations. Precision@k is the proportion of ground-truth items in the recommendations. Similar@k is the similarity of the ground-truth items and recommended items determined by computing the cosine distance between the embedding centroids. In the present evaluation, embeddings (e.g., simple contrastive learning of sentence embeddings (SimCSE)) are obtained from item descriptions. The metrics are averaged across all requests.

Uniqueness: The concept of uniqueness with respect to recommendations may be linked to an item's popularity, such as the number of ratings it has received. Thus, a metric that uses item popularity is used, where Pop50@k is the proportion of items in the top-50-most popular (or well-known) items, ranked by upvotes. Lower values indicate a greater degree of uniqueness since popular items are often listed on a platform's homepage, and the objective of the practicable CRS is to help users discover unfamiliar items. Also used is RPop50@k, which computes the ratio of Pop50@k for the recommended items to that of the ground-truth items. A value close to 1 indicates that the recommendation is as unique or is close to being as unique as the ground-truth items.

Coverage: Entropy@k measures the diversity of recommended items across all requests, formally computed by the following equation: Entropy@k=−Σᵢpᵢ log(pᵢ), where pᵢ is defined as the frequency of item i across the top-k recommendations. Higher entropy indicates a wider coverage of items. Maxfreq@k identifies the most frequently recommended item and computes the proportion of requests for which this item is recommended. For example, if “Adopt Me!” appears in the top-10 list in 60% of the requests, then MaxFreq@10 is 0.60. A lower value is preferable, as it indicates that the system avoids recommending the same item repeatedly.

Factuality: Factual@k measures the proportion of real items in the top-k list. If the get_id_from_fuzzy_name returns nothing, the item name is regarded as a hallucination. While factuality may be addressed by displaying the actual items to the user, it remains a notable metric for understanding model performance. The other metrics are computed after filtering out the hallucinated items.

For the testing setup, a first LLM (e.g., LLaMA-405B) and a second LLM (e.g., GPT-4o) may be used. The temperatures of these LLMs may be set to zero for deterministic results. For simplicity, the same LLM(s) may be used for formatting and recommendation. In some implementations, two stages may be run by different LLMs.

The results of ablation tests show the benefit of executing a larger and more diverse set of tools, as compared to other techniques. The baselines used in the ablation tests are as follows:
1) Pop randomly selects k items from the top-50 list;
2) Base LLM is an LLM without any tool augmentations;
3) Base LLM+Div is a slight variant that encourages the base LLM to generate lesser-known items by simply adding an instruction (e.g., “The games should be diverse and not too well known (should be new to the user).”); and
4) OMuleT w/P_{LLM} replaces the tool-execution policy P with LLM-generated ones, to observe whether LLMs can generate better policies than P. The LLM is provided with the natural-language user request, formatted intent, and a list of available tools and instructs to generate a code in Python (or another suitable/analogous programming language) that outputs D_{aug}.

The results answer various performance-related questions. One such question includes “is OMulet more effective than base LLMs?” As shown in FIG. 7, OMuleT outperforms LLMs in all metrics for the human-annotated dataset (italicized). For the full dataset, the OMuleT outperforms the base LLaMA-405B in all metrics and GPT-4o in all but hit and precision; this discrepancy may be attributed to the lack of accurate ground-truth items for the full dataset. Base LLMs have particularly poor uniqueness and coverage; LLaMA-405B recommends top-50 items×3.19 more frequently than ground-truth items and recommends the most frequent item (“Natural Disaster Survival”) in 43% of requests. This differs from OMuleT, where LLA-405B recommends top-50 items×1.31 more than the ground-truth items and recommends the most frequent item in 10% of requests. While OMulet achieves near-perfect factuality (>99%), base LLMs generate hallucinations among 21% (LLaMA-405B) and 11% (GPT-4o) of top-10 recommendations.

Another such question includes “does tool-executed policy P outperform an LLM-generate policy?” Still referring to FIG. 7, to answer this question, it was determined whether LLMs can generate their own policies, P_{LLM}, per request using the same toolbox, to determine if they can create more effective, customized policies. It was determined that although LLMs generate reasonable policies, relevance metrics significantly drop compared to using the tool-execution policy P. It was observed that high coverage (entropy) occurred in some cases, but the overall results show that there is little or no advantage of using P_{LLM} over tool-executed policy P, at least in part, because the former approach is less transparent and controllable. That said, OMuleT with P_{LLM} consistently outperforms base LLMs in factuality, uniqueness, and coverage, and occasionally in relevance, which may suggest that retrieving any relevant results is preferable to none for factual and diverse recommendations.

Still another such question includes “can LLMs be prompted to recommend more diverse items?” Referring again to FIG. 7, base LLMs indeed generate more diverse items (higher uniqueness and coverage) when explicitly prompted to do so, but this leads to a significant loss in relevance (55-64% of unprompted) and factuality (64-81% of unprompted). While simple prompting yields higher uniqueness than OMuleT when k=10, the differences are relatively small (e.g., 1.25 vs. 1.31 for LLaMA and 1.04 vs. 1.61 for GPT-4o in RPop).

FIG. 8 is a diagram illustrating results of an ablation study 800 on the number of tools executed in the tool-execution policy, in accordance with some implementations.

The results of the ablation study 800 are shown where each tool was individually removed from the tool policy to observe the impact on performance. As shown, using all the tools generally improves performance, with two unexpected results. One is that the performance of LLaMA-405B significantly drops when a tool is omitted. A possible explanation is that augmenting with partial information may mislead the model (e.g., by providing similar games but not age-relevant games). The LLaMA-405B may also be sensitive to noise when the filtering tool is not used. Another result is that dropping the search tool may slightly increase relevance (although at the cost of uniqueness and coverage) for GPT-4o. To understand this, the search tool's outputs were examined. One issue is that the search API sometimes returns noisy results, such as retrieving low-quality games. But another problem is that many user-described properties, such as “sweet,” “not too horror,” “no progression,” “nice people,” “unique premise,” and so on, can be ambiguous or incompatible with search queries. OMuleT is designed to handle such nuanced requests by letting LLM(s) understand the request holistically (e.g., “sweet” as the game “Oobja,” or “not too horror” as less intense than “The Mimic”) and use the provided game descriptions to match them with the request. However, their descriptions alone may not provide enough context to accurately match items with requests. One way to address this issue is to obtain descriptions of actual gameplay or user opinion. In terms of uniqueness and coverage, using all tools yields similar or better performance results than when one or more tools are omitted.

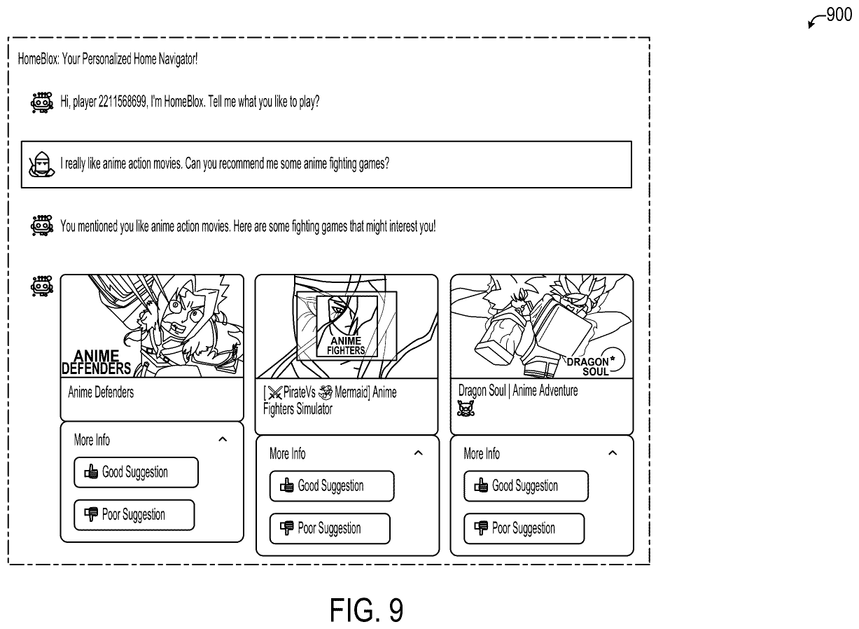

FIG. 9 illustrates a diagram of an example user interface 900 (e.g., a graphical user interface provided by the I/O interface(s) 114/134 and/or by other component(s) usable in the system architecture 100 of FIG. 1) for presenting results of practicable conversational recommendation, in accordance with some implementations. As depicted in FIG. 9, several simple greetings and explanations are provided for a more natural conversation, and thumbs up and down buttons for obtaining recommendation feedback.

To perform a feasibility study and identify the best implementation practices, an internally hosted chatbot (e.g., user interface 900) may be used. The application may be built on a full-stack server, which simplifies creating an interactive user interface and managing backend operations. The application may be deployed in an internal datacenter for cluster orchestration, deployment, and configuration.

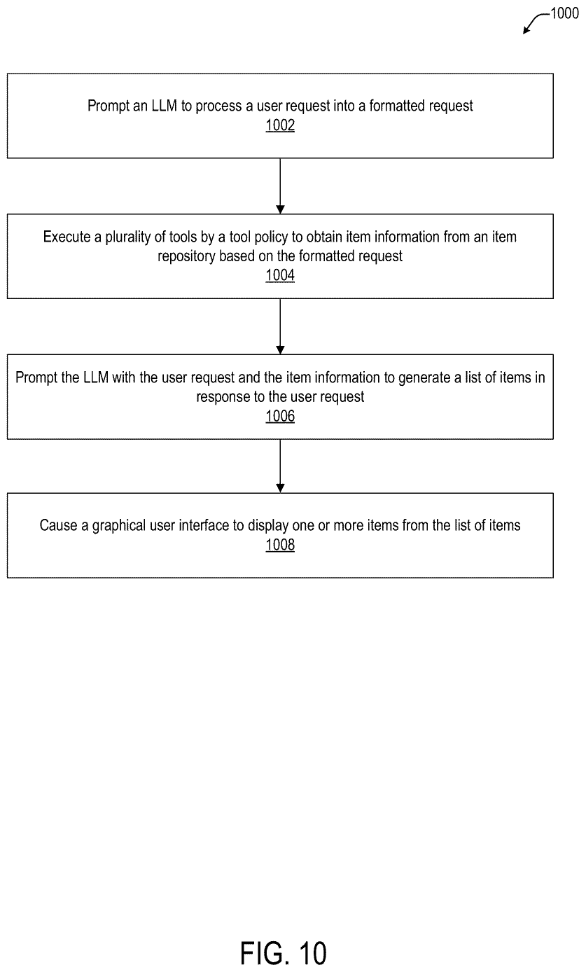

FIG. 10 is a flowchart of an example method 1000 of practicable conversational recommendation, in accordance with some implementations.

In some implementations, method 1000 can be implemented, for example, on an online virtual experience server 102 (e.g., by a virtual-experience coordinator) described with reference to FIG. 1 and which implements the practicable CRS 400 of FIG. 4. In some implementations, some or all of the method 1000 can be implemented on one or more client devices 110 as shown in FIG. 1, on one or more developer devices 130, or on one or more online virtual experience server(s) 102, and/or on a combination of developer device(s), server device(s) and client device(s), and/or on other device(s) usable in the system architecture 100 of FIG. 1. In described examples, an implementing system may include one or more digital processors or processing circuitry (“processors”), and one or more storage devices (e.g., a data store 120 or other storage). In some implementations, different components of one or more servers and/or clients can perform different blocks or other parts of the method 1000. In some examples, a first device is described as performing blocks of method 1000. Some implementations can have one or more blocks of method 1000 performed by one or more other devices (e.g., other client devices or server devices) that can send results or data to the first device.

In some implementations, method 1000, or portions of the methods, can be initiated automatically by a system. In some implementations, the implementing system is a first device. For example, the method (or portions thereof) can be periodically or otherwise repeatedly performed or performed based on one or more particular events or conditions (e.g., upon a user request and/or one or more other conditions occurring which can be specified in settings read by the method(s)/computing device). In the method 1000 of FIG. 10 and in other methods/operations described herein, some operations may be optional, modified, omitted, combined, supplemented with other operations, performed in a different order than as shown (e.g., sequentially, in parallel, etc.), and so forth.

Referring to FIG. 10, method 1000 may begin at block 1002. At block 1002, an LLM may be prompted to process a user request based on a formatted structure into a formatted request. The user request may be in a natural language format.

In some implementations, the formatted request may be in human-readable format.

In some implementations, the formatted request has a formatted structure that includes user preferences and user demographics. In some implementations, the user preferences specify one or more attributes from item genre, item name, item properties, and item compatibility, and a value that indicates whether an attribute of the one or more attributes is a positive attribute or a negative attribute. In some implementations, the user demographics specify one or more of gender, age, location, or a combination thereof. Block 1002 may be followed by block 1004.

At block 1004, a plurality of tools may be executed by a tool policy to obtain item information from an item repository based on the formatted request.

In some implementations, executing the plurality of tools by the tool policy to obtain the item information based on the formatted request includes, for an individual content-item title or an individual content-item genre indicated in the formatted request, returning, by at least one lookup tool, content-item metadata corresponding to a respective content-item title indicated in the formatted request.

In some implementations, executing the plurality of tools by the tool policy to obtain the item information based on the formatted request includes, for an individual content-item title or an individual content-item genre indicated in the formatted request, matching, by at least one linking tool, one or more of an official content-item title to the individual content-item title indicated in the formatted request or an official content-item category to the individual content-item genre indicated in the formatted request.

In some implementations, executing the plurality of tools by the tool policy to obtain the item information based on the formatted request includes, for an individual content-item title or an individual content-item genre indicated in the formatted request, retrieving, by at least one retrieval tool, at least one unspecified content item similar to a content item corresponding to the individual content-item title indicated in the formatted request.

In some implementations, executing the plurality of tools by the tool policy to obtain the item information based on the formatted request includes summarizing, by at least one formatting tool, results of one or more of a lookup tool, a linking tool, or a retrieval tool into a human-readable form.

In some implementations, executing the plurality of tools by the tool policy to obtain item information based on the formatted request further includes implementing, by an integrity tool, safety protocols to prevent one or more of irrelevant queries, policy violations, or jailbreaks.

In some implementations, the formatted request includes a blocked genre. In some implementations, the tool policy specifies that items that are associated with the blocked genre are to be excluded from the list of items.

In some implementations, individual tools of the plurality of tools include an executable program that is configured to access the item repository. In some implementations, executing the plurality of tools includes running the executable program with one or more parameters obtained from the formatted request. Block 1004 may be followed by block 1006.

At block 1006, the LLM may be prompted with the user request and the item information to generate a list of items in response to the user request.

In some implementations, prompting the LLM with the user request and the item information to generate the list of items in response to the user request includes prompting the LLM with the user request and item information to generate a ranked list of items in response to the user request.

In some implementations, prompting the LLM with the user request and the item information to generate a list of items in response to the user request includes instructing the LLM to generate a ranked list of N content-item recommendations based on the user request and the item information.

In some implementations, the LLM includes a first model and a second model different from the first model. In some implementations, the formatted request is generated by the first model and the list of items is generated by the second model. Block 1006 may be followed by block 1008.

At block 1008, a graphical user interface may be caused to display one or more items from the list of items.

In some implementations, causing the graphical user interface to display the one or more items from the list of items includes causing the graphical user interface to display the one or more items from the ranked list of items based on their respective ranks. Block 1008 may conclude the operations of method 1000.

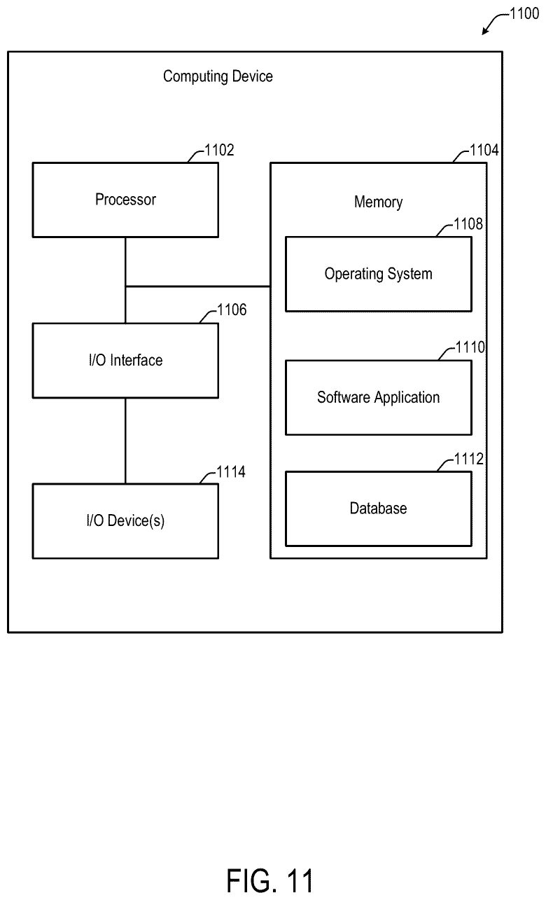

Hereinafter, a more detailed description of various computing devices that may be used to implement different devices and/or components illustrated in FIG. 1 is provided with reference to FIG. 11.

FIG. 11 is a block diagram of an example computing device 1100 which may be used to implement one or more features described herein, in accordance with some implementations. In one example, computing device 1100 may be used to implement a computing device (e.g., 102, 110, etc. of FIG. 1), and perform appropriate operations as described herein. Computing device 1100 can be any suitable computer system, server, or other electronic or hardware device. For example, the computing device 1100 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1100 includes a processor 1102, a memory 1104, input/output (I/O) interface 1106, and audio/video input/output devices 1114 (e.g., display screen, touchscreen, display goggles or glasses, audio speakers, headphones, microphone, etc.).

Processor 1102 can be one or more processors and/or processing circuits to execute program code and control basic operations of the computing device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1104 is typically provided in computing device 1100 for access by the processor 1102 and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1102 and/or integrated therewith. Memory 1104 can store software operating on the computing device 1100 by the processor 1102, including an operating system 1108, software application 1110, and associated database 1112. In some implementations, the software application 1110 can include instructions that enable processor 1102 to perform the functions described herein. Software application 1110 may include some or all of the functionality used to perform practicable conversational recommendation. In some implementations, one or more portions of software application 1110 may be implemented in dedicated hardware such as an application-specific integrated circuit (ASIC), a programmable logic device (PLD), a field-programmable gate array (FPGA), a machine learning processor, etc. In some implementations, one or more portions of software application 1110 may be implemented in general purpose processors, such as a central processing unit (CPU) or a graphics processing unit (GPU). In various implementations, suitable combinations of dedicated and/or general purpose processing hardware may be used to implement software application 1110.

For example, software application 1110 stored in memory 1104 may include instructions for performing practicable conversational recommendation and/or other functionality or software such as the virtual experience engine 104 and/or virtual experience application 112. The software application 1110 and/or other executable computer-readable instructions stored in memory 1104 can also be used to implement the virtual experience application 112, the virtual experience engine 104, the virtual experience 106, and/or other components depicted in and/or otherwise usable for the system architecture 100 of FIG. 1. Any of software in memory 1104 can alternatively be stored on any other suitable storage location or computer-readable medium. In addition, memory 1104 (and/or other connected storage device(s)) can store instructions and data used in the features described herein. Memory 1104 and any other type of storage (magnetic disk, optical disk, magnetic tape, or other tangible media) can be considered “storage” or “storage devices.”

I/O interface 1106 (which can correspond to the I/O interface 114/134 of FIG. 1) can provide functions to enable interfacing the computing device 1100 with other systems and devices. For example, network communication devices, storage devices (e.g., memory and/or data store 120), and input/output devices can communicate via interface 1106. In some implementations, the I/O interface 1106 can connect to interface devices including input devices (keyboard, pointing device, touchscreen, microphone, camera, scanner, etc.) and/or output devices (display device, speaker devices, printer, motor, etc.).

For ease of illustration, FIG. 11 shows one block for each of processor 1102, memory 1104, I/O interface 1106, operating system 1108, software application 1110, and database 1112. These blocks may represent one or more processors or processing circuitries, operating systems, memories, I/O interfaces, applications, and/or software modules. In other implementations, computing device 1100 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the computing device 1100 (e.g., processor(s) 1102, memory 1104, and I/O interface 1106). An operating system, software and applications suitable for the client device can be provided in memory and used by the processor. The I/O interface for a client device can be connected to network communication devices, as well as to input and output devices (e.g., a microphone for capturing sound, a camera for capturing images or video, audio speaker devices for outputting sound, a display device for outputting images or video, or other output devices). A display device within the audio/video input/output devices 1114, for example, can be connected to (or included in) the computing device 1100 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

The methods, blocks, and/or operations described herein can be performed in a different order than shown or described, and/or performed simultaneously (partially or completely) with other blocks or operations, where appropriate. Some blocks or operations can be performed for one portion of data and later performed again (e.g., for another portion of data). Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 1000) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), for example, a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to provide automatic conversational recommendations, comprising:
prompting a large language model (LLM) to process a user request into a formatted request, wherein the user request is natural language text;
executing a plurality of tools by a tool policy to obtain item information from an item repository based on the formatted request;
prompting the LLM with the user request and the item information to generate a list of items in response to the user request; and
causing a graphical user interface to display one or more items from the list of items.

2. The computer-implemented method of claim 1, wherein the formatted request is in human-readable format.

3. The computer-implemented method of claim 1, wherein prompting the LLM with the user request and the item information to generate the list of items in response to the user request comprises:
prompting the LLM with the user request and item information to generate a ranked list of items in response to the user request.

4. The computer-implemented method of claim 3, wherein causing the graphical user interface to display the one or more items from the list of items comprises:
causing the graphical user interface to display the one or more items from the ranked list of items based on their respective ranks.

5. The computer-implemented method of claim 1, wherein:
individual tools of the plurality of tools include an executable program that is configured to access the item repository, and
executing the plurality of tools comprises running the executable program with one or more parameters obtained from the formatted request.

6. The computer-implemented method of claim 1, wherein executing the plurality of tools by the tool policy to obtain the item information based on the formatted request comprises:
for an individual content-item title or an individual content-item genre indicated in the formatted request,
returning, by at least one lookup tool, content-item metadata corresponding to the individual content-item title indicated in the formatted request.

7. The computer-implemented method of claim 1, wherein executing the plurality of tools by the tool policy to obtain the item information based on the formatted request comprises:
for an individual content-item title or an individual content-item genre indicated in the formatted request,
matching, by at least one linking tool, one or more of an official content-item title to the individual content-item title indicated in the formatted request or an official content-item category to the individual content-item genre indicated in the formatted request.

8. The computer-implemented method of claim 1, wherein executing the plurality of tools by the tool policy to obtain item information based on the formatted request comprises:
for an individual content-item title or an individual content-item genre indicated in the formatted request,
retrieving, by at least one retrieval tool, at least one unspecified content item similar to a content item corresponding to the individual content-item title indicated in the formatted request.

9. The computer-implemented method of claim 1, wherein executing the plurality of tools by the tool policy to obtain item information based on the formatted request comprises:
summarizing, by at least one formatting tool, results of one or more of a lookup tool, a linking tool, or a retrieval tool into a human-readable format.

10. The computer-implemented method of claim 1, wherein executing the plurality of tools by the tool policy to obtain item information based on the formatted request further comprises:
implementing, by an integrity tool, safety protocols to prevent one or more of irrelevant queries, policy violations, or jailbreaks.

11. The computer-implemented method of claim 1, wherein prompting the LLM with the user request and the item information to generate the list of items in response to the user request comprises:
instructing the LLM to generate a ranked list of N content-item recommendations based the user request and the item information.

12. The computer-implemented method of claim 1, wherein:
the formatted request includes a blocked genre, and
the tool policy specifies that items that are associated with the blocked genre are to be excluded from the list of items.

13. The computer-implemented method of claim 1, wherein:
the LLM includes a first model and a second model different from the first model, and
the formatted request is generated by the first model and the list of items is generated by the second model.

14. The computer-implemented method of claim 1, wherein:
the formatted request has a formatted structure that includes user preferences and user demographics,
the user preferences specify one or more attributes from item genre, item name, item properties, and item compatibility, and a value that indicates whether an attribute of the one or more attributes is a positive attribute or a negative attribute, and
the user demographics specify one or more of gender, age, location, or a combination thereof.

15. A non-transitory computer-readable medium with instructions stored thereon that, when executed by one or more hardware processors, cause the one or more hardware processors to perform or control performance of operations comprising:
prompting a large language model (LLM) to process a user request into a formatted request, wherein the user request is natural language text;
executing a plurality of tools by a tool policy to obtain item information from an item repository based on the formatted request;
prompting the LLM with the user request and the item information to generate a list of items in response to the user request; and
causing a graphical user interface to display one or more items from the list of items.

16. The non-transitory computer-readable medium of claim 15, wherein:
prompting the LLM with the user request and the item information to generate the list of items in response to the user request comprises:
prompting the LLM with the user request and item information to generate a ranked list of items in response to the user request; and
causing the graphical user interface to display the one or more items from the list of items comprises:
causing the graphical user interface to display the one or more items from the ranked list of items based on their respective ranks.

17. The non-transitory computer-readable medium of claim 15, wherein executing the plurality of tools by the tool policy to obtain the item information based on the formatted request comprises:
for an individual content-item title or an individual content-item genre indicated in the formatted request,
returning, by at least one lookup tool, content-item metadata corresponding to the individual content-item title indicated in the formatted request;
matching, by at least one linking tool, one or more of an official content-item title to the individual content-item title indicated in the formatted request or an official content-item category to the individual content-item genre indicated in the formatted request; and
retrieving, by at least one retrieval tool, at least one unspecified content item similar to a content item corresponding to the individual content-item title indicated in the formatted request; and
summarizing, by at least one formatting tool, results of one or more of a lookup tool, a linking tool, or a retrieval tool into a human-readable format.

18. The non-transitory computer-readable medium of claim 15, wherein prompting the LLM with the user request and the item information to generate a list of items in response to the user request comprises:
instructing the LLM to generate a ranked list of N content-item recommendations based the user request and the item information.

19. The non-transitory computer-readable medium of claim 15, wherein:
the LLM includes a first model and a second model different from the first model, and
the formatted request is generated by the first model and the list of items is generated by the second model.

20. A computing device, comprising:
one or more hardware processors; and
a non-transitory computer readable medium coupled to the one or more hardware processors, with instructions stored thereon, that when executed by the one or more hardware processors, cause the one or more hardware processors to perform or control performance of operations comprising:
prompting a large language model (LLM) to process a user request into a formatted request, wherein the user request is natural language text;
executing a plurality of tools by a tool policy to obtain item information from an item repository based on the formatted request;
prompting the LLM with the user request and the item information to generate a list of items in response to the user request; and
causing a graphical user interface to display one or more items from the list of items.
